(19) United States
(12) Patent Application Publication
(10) Pub. No.: US 2017/0193230 A1
(43) Pub. Date: Jul. 6, 2017

(54) REPRESENTING AND COMPARING FILES BASED ON SEGMENTED SIMILARITY

(71) Applicant: Microsoft Technology Licensing, LLC, Remond, WA (US)

(72) Inventors: Roy Jevnisek, Givatayim (IL); Tomer Brand, Hod HaSharon (IL); Patrick Estavillo, Langley (CA); Marian Radu, Munich (DE)

(21) Appl. No.: 14/702,750

(22) Filed: May 3, 2015

(51) Int. Cl. G06F 21/56

(52) U.S. Cl. CPC G06F 21/565; G06F 2221/034

(57) ABSTRACT

Disclosed herein is a system and method for determining whether two files are similar or an unknown file contains malware or other malicious activity. The system takes a suspect file and generates a hash for the file. The hash represents segments of a file that may be compared with segments of other hashes. This hash is then compared with the hash of another file. The comparison measures the distance between the two hashes and if the two hashes are close enough to each other then the two files are consider similar to each other.

### BACKGROUND

Malware detection and identification is a complex process that requires a substantial amount of human involvement. Developers of malware are always trying to outsmart the malware detection and removal companies by constantly adapting and modifying the shape and behavior of the malware. As malware detection relies on signatures malware developers are able to stay one step ahead of the detection companies through this constant changing and adapting of their malware files requiring the malware detection companies to constantly adapt the signatures to detect the changed malware. One approach taken by the malware authors is to obfuscate the malware in a file by encrypting the code or breaking the code into encrypted portions. Each of these obfuscator tools leave a different, somewhat unique, footprint in the generated file version

Current malware detection relies on companies and individuals to submit samples of malware or suspected malware after an infection or attack has occurred. A malware researcher will analyze the file and develop a signature for that file. This signature will then be pushed out to the detection programs so that the file will be identified in the future as malware. With encrypted malware the malware researcher spends a large amount of time decrypting the code and finding the particular snipits of the code in a file.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a system and method for determining whether an unknown file contains malware or other malicious activity. The system takes a suspect file and generates a hash for the file structure which profile the obfuscation tool used to generate the sample. This hash is then compared with the hash of another file. This other file may be a benign file or may be a file that is known to have malware in it. The comparison measures the distance between the two hashes and if the two hashes are close enough to each other, then the two files considered to be the output of the same obfuscation tool, hence considered similar to each other.

To generate the hash of the file the system preprocesses the file to convert the file in to a signal representative of the file. This signal is then processed to identify segments in the file based on a sliding comparison of two windows. As each segment is identified transition points are noted. These points define where a segment begins or ends in a file. Once the segments have been identified the process continues to identify a statistical property for each of the segments that is indicative of the level of encryption found at a particular segment. These are combined to form the hash of the file representing the list of transition points/segments and a list of the level values (statistical properties) for the segments. Those segments are the ‘signature’ of the encryption tool used

Once the hash has been generated for the file it is compared to a hash for a known file. The process determines the distance between the two hashes using two calculations. The first calculation is a determination of the area between the curves represented by the two hashes. The second is a determination of a difference in the structure of the two files. These results are combined to form the overall distance measurement for the file. The distance measurement is compared against a threshold value for distance to determine if the files are similar or not. This information can be provided to a malware detection program or other program for appropriate action to be taken.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is as block diagram illustrating components of a system for segmenting and determining if files are similar to each other according to one illustrative embodiment.

FIG. 2 illustrates a graphical representation of a hash according to one illustrative embodiment.

FIG. 3 illustrates a graphical representation of a second hash according to an illustrative embodiment.

FIG. 4 illustrates the area between two hashes according to an illustrative embodiment.

FIGS. 5 and 6 illustrate graphical representations of two hashes according to an illustrative embodiment.

FIG. 7 illustrates the hashes of FIGS. 5 and 6 superimposed on each other.

FIG. 8 illustrates the area between the hashes of FIGS. 5 and 6.

FIG. 9 is a flow diagram illustrating a process that may be implemented by the system to prepare a hash for a file according to one illustrative embodiment.

FIG. 10 is a flow diagram illustrating a process for determining if two files are similar to each other.

FIG. 11 illustrates a component diagram of a computing device according to one embodiment.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. This is distinct from computer storage media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media, but not with computer storage media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

Historically, anti-malware software relied heavily on static signatures. Static signatures scan a portable executable file, searching for pre-specified byte patterns. To write a signature an analyst must hold a sample, reverse engineer it, and define the fragments to be searched. This is a long procedure that demands high proficiency and the effort of acquiring the sample.

To avoid detection, malware authors hide the core code that executes the malicious act with various obfuscation techniques and tools. According to our observations, many of the top prevalent malware families use obfuscation to avoid detection. For example, the Neurevet malware family uses many types of obfuscators. Code obfuscation bears many shapes and each technique has a different impact on the produced file structure. To avoid signature detection, malware authors encrypt the malicious part of the code, and add a decryption routine to it. As the code is run, the decryptor decrypts the file usually to memory, and the malicious code is then run.

In the past, malware authors used off-the-shelf encryptors. As a result, many anti-virus vendors included those public routines in the anti-malware software as a preprocessing step prior to running the signatures. This in turn resulted in more and more malicious authors to create custom encryptors to encrypt their malware. In response to this approach the malware analysts must turn back to analyzing a sample of the code, finding the de-obfuscation routine and incorporating it in the anti-malware engine. This process is extremely costly to the anti-malware vendors in terms of time, difficulty and sample availability.

Gathering samples of obfuscated malware for such analysis relies on the ability to distinguish between encrypted and non-encrypted files. Entropy is a common way to measure whether a file is encrypted or not, as encrypted files typically have high entropy. However, entropy is a global measure, which means that it is calculated based on the entire file. This is a great drawback, because malware authors then divide the file into multiple sections and encrypt only some of them. Additionally they may add a constant piece of code that never runs which again lowers the entropy. Using these two tricks one can tune the entropy of a file to any number to further avoid detection.

The identification of malware has been a constant game of cat and mouse between developers of malware or malware authors who desire to inflict their malicious code on computer systems and the analysts who try to block the malware from taking hold and inflicting the damage on users and computer systems. Malware developers constantly change or modify their tactics in creating the malware to make it more difficult for anti-malware programs to identify, isolate and remove malware. Typically malware is identified when users submit samples of malware to a malware researcher after their system has become infected by the malware component. The researcher investigates a submitted malware sample and determines if the sample is in fact malware and not something else and if it is malware then the researcher identifies a signature for the malware. This malware signature is then published so that anti-malware programs can make use of the signature to identify a file as malware when presented to a system hosting the anti-malware program.

However this approach to identifying malware is extremely labor intensive as the researcher must evaluate each submitted malware candidate to determine if the candidate is in fact malware. Worldwide there are very few malware researchers actively handling malware samples. Often these malware researchers are all looking at the same or similar malware candidates. This reduces the number of unique malware candidates that can be looked at on a daily basis. Current estimates indicate that there are over 200,000 new malware samples produced each day and approximately 500,000 files reported as suspect files. The sheer numbers of suspect files and the number malware samples generated daily and the time it takes to manually analyze the suspect files and generate an associated signature for actual malware makes it more likely that a malware sample may run in the wild for a number of days before a signature is found and published.

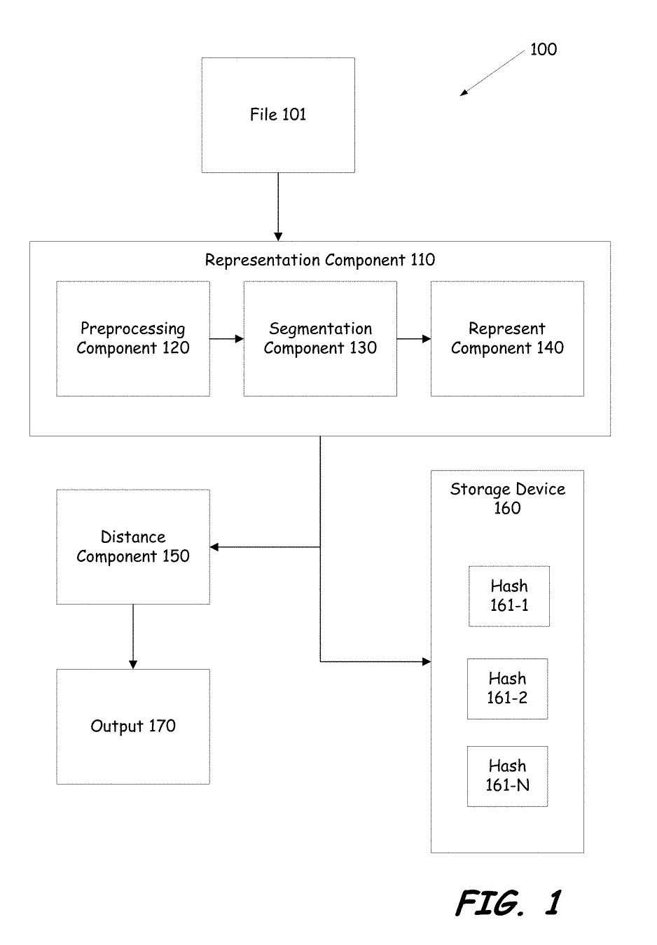

FIG. 1 is a block diagram of a system 100 for segmenting and determining if files are similar to each other or have components parts that are similar to each other that can be used for grouping and framing obfuscated malware in files based on their encryption method. System 100 includes at least one file 101 to be analyzed, a representation component 110 and a distance component 150. The representation component 110 can further include a preprocessing component 120, a segmentation component 130 and a represent component 150.

The representation component 110 is a component of the system 100 that is configured to receive as an input file 101 and to produce as an output a hash 102. The hash 102 is in one approach includes a list of transitions, and a list of levels. In some approaches a list of variances may also be output in the hash 102. The hash 102 represents both the encryption levels and the byte span of segments of a file. This results in a model of the file's structure, which is a byproduct of the obfuscation/encryption tool used. Different files may exhibit similar characteristics such as a similar encryption level with dissimilar structure. The representation component 110 is able to distinguish between these two different files. Further, the representation can allow for anomaly detection to be applied to identify files whose structures appear erroneous or ill-structured which can be indicative of malware. The representation component 110 adapts the size of the representation based on the particulars of the specific file 101 that is being analyzed. This approach helps to ensure that important pieces or segments of the file are not missed while also keeping the size of the segments to the smallest or shortest size possible.

To generate the hash for the file is first provided to the preprocessing component 120. The preprocessing component 120 is a component of the representation component 110 that takes the file and converts the file into a signal. Each point in the signal represents a local entropy for the file at that point. The file 101 can be any type of file that is a binary file.

Again the purpose of the preprocessing phase is to convert the binary file to a processed signal. Each point in the processed signal represents a local measure of disorder. However, prior to discussing the implementation of how disorder is measured a definition of disorder is useful. Taking a byte in a binary file and its neighboring bytes gives a local measure. This group of bytes are in disorder if their arrangement is unique (high entropy) and in order if they are common (low entropy). For example a set of “0x90”, which means “no operation” in assembly, are quite common thus will produce a low local measure of disorder.

The preprocessing component 120 can use any method to identify and represent disorder in a signal. In one approach the preprocessing component 120 uses Huffman codes to represent disorder. In this approach the preprocessing component 120 counts the prevalence of bytes in the file and normalizes this to a probability function (by dividing by the file size). This normalized vector is used as an estimate for the probability density function required to generate Huffman codes. Replacing each byte with its Huffman code does not provide a local measure. The preprocessing component 120 needs to average in a window of defined size to arrive at a local estimate. The output of the preprocessing phase managed by the preprocessing component 120 is a signal with a size equal to the original file.

The segmentation component 130 is a component of the representation component 110 that is configured to divide the signal generated by the preprocessing component 120 into segments based on statistical differences in the segments. The segmentation component 130 applies a segmentation algorithm that compares the statistics of two parts of the file. This is done by opening two adjacent windows and estimating some statistical measures in those windows. A window is used herein to define a certain number of bytes in the signal that are considered to be a segment. The segmentation component 130 can adjust the size of the window based on the process described herein, and it should also be noted that segments are not necessarily the same size. For example, the segmentation component 130 can begin by looking at the first 100 points in the preprocessed signal and then comparing that with the next 100 points in the preprocessed signal. This forms the two adjacent windows. In this example, points 1-100 are in window 1 and points 101-200 are in window 2.

For the estimation of the statistical measures between the two windows the segmentation component 130 can use in some approaches moments or entropy between the windows. For moments the mean value, variance or other comparative measure can be used. When the segmentation component 130 uses entropy for the statistical measure the entropy in each window can be measured and the compared with the measured entropy of the other window. In some approaches the segmentation component 130 can use a raw probability distribution function estimation for each of the windows and then measure the distance between the two calculated estimations. One example to measure the distances is the Kullback-Leibler divergence measure. However, other distance measures can be used.

The segmentation component 130 compares the statistical measures for each of the windows with each other. The difference between the two statistical measures is compared with a threshold value. The threshold value can be either a constant threshold value, that is the value does not change, or can be an adaptive threshold value. In some approaches a user can determine what the threshold value should be or may indicate to the system the desired sensitivity of the threshold. The system can then tune itself appropriately to have the correct threshold values for the user's desired results. If the statistical measure between the two windows exceeds a threshold value the boundary point between the two windows is identified as a transition point. In the example above if the windows were 1-100 and 101-200 the boundary point would be identified as byte 100. This location is held for the final hash to be generated. However, if the comparison falls below the threshold value for the distance the segmentation component 130 expands the size of the first window by a predetermined size. In one approach the size of the first window is increased by one byte position. However, other expansions can be considered. The second window is then shifted that same number of byte positions. Thus, in the example above, the first window now goes from byte positions 1-101 while the second window goes from positions 102-201. It should be noted in the optimal case the second window does not expand and remains the same size throughout the segmentation process.

The segmentation component 130 after finding the first transition point in the signal moves the first window to begin at the first transition point and the second window will begin at a point in the signal that is at the end of the size of the first window's original size. So in the example above, and presuming that the transition point was found 12 points into the signal, the first window would now run from point 112 to point 211 and the second window would run from point 212 to point 311. The segmentation component 130 repeats this process of identifying the transition points until it reaches the end of the file. The output of the segmentation component 130 is a segmented version of the signal and a list of transition points.

The represent component 150 is a component of the representation component 110 that creates the representation of the file in a compact manner. Specifically, each of the segments is represented by a value that is indicative of the level of encryption or compression that is applied to that particular segment. To represent each segment the represent component 150 may use the same statistical properties that were used in the segmenting process performed by the segmentation component 130. However, different statistical properties can be used to represent the segment. The represent component 150 performs the represent process for each segment that was identified by the segmentation component 130. These values are then combined with the values from the segmentation component 130 to generate the hash for the file.

TABLE 1

| Start Byte | End Byte | Mean |
|---|---|---|
| 0 | 26411 | 0.720577 |
| 26412 | 39583 | 0.532817 |
| 39584 | 138500 | 0.892338 |
| 138501 | 146265 | 0.709563 |
| 146266 | 172067 | 0.528986 |
| 172068 | 1467057 | 0.900903 |

Table 1 above illustrates an exemplary hash for a file. In this particular hash the system has chosen to use the mean value as the represent value for each of the segments. During segmentation the segmentation component 130 identified 6 different segments with the transition points indicated by the values in the End Byte column. In this example table the higher the mean value illustrated indicates a higher level of encryption/compression. Thus, the first segment has a medium level of encryption, the second segment a low level of encryption, the third segment has a high level of encryption, and so forth.

The representation component 110 outputs the full hash for the file. The full hash for the file may be stored in a storage component 160 such as storage component 160. Storage component 160 is any storage device that is connected to the system that can store a hash. In some approaches the storage component 160 stores the file with the hash. In other approaches the hash is stored separately from the file, but the storage component 160 can include a reference or other identifier that allows for the retrieval of the hash when the corresponding file is being analyzed. The stored hashes are illustrated as hashes 161-1, 161-2, 161-N

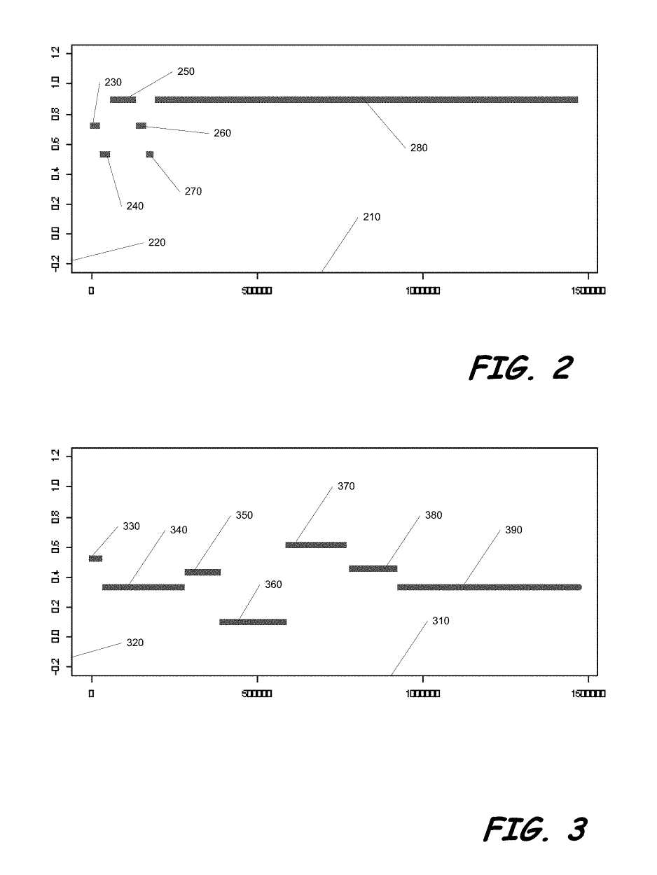

The distance component 150 is a component of the system 100 that measures the difference between two files based on their corresponding hashes. To assist in better understanding this distance measurement of the hashes it is helpful to visualize the hash as a graph. FIG. 2 illustrates a graphical representation of the hash illustrated in TABLE 1 above. Axis 210 of graph 200 represents the bytes of the file or hash. Axis 220 represents the mean or value of the hash for each segment. Lines 230, 240, 250, 260, 270 and 280 correspond to six segments of TABLE 1. FIG. 3 illustrates a second hash 300 that will be compared with the hash. Similar to FIG. 2 axis 310 represents the bytes of the corresponding file and axis 320 represents the mean or value of the hash for each segment. Hash 300 was processed in the same way as the hash for graph 200 resulting in seven segments being found. They are represented by lines 330, 340, 350, 360, 370, 380 and 390. The distance component 150 obtains both of these hashes from the storage component 160. However, in some approaches these hashes can be generated on demand by the distance component 150. The distance component 150 then calculates the area between the segments of the two hashes.

This portion of the calculation can be illustrated mathematically by the following equation.

$${\int }_{0}^{nBytes} dist ( {h}_{1} ( x ) , {h}_{2} ( x ) ) dx \qquad EQUATION 1$$

Where h₁,h₂ represent the two different hashes and nBytes represents the total number of bytes in the hashes. While the illustrated hashes relate to files that are the same length in terms of the number of bytes it is possible that the compared files and hence hashes will not be the same length. In those instances the distance component 150 can perform one of two options. The first option is for the distance component 150 to scale the two hashes to be the same length. This can be done for example by determining the percentage of the hash that each segment represents and then adjusting all of the segments to the larger size. The second option is to augment the shorter signal with a segment of all zeros until the correct file size is achieved.

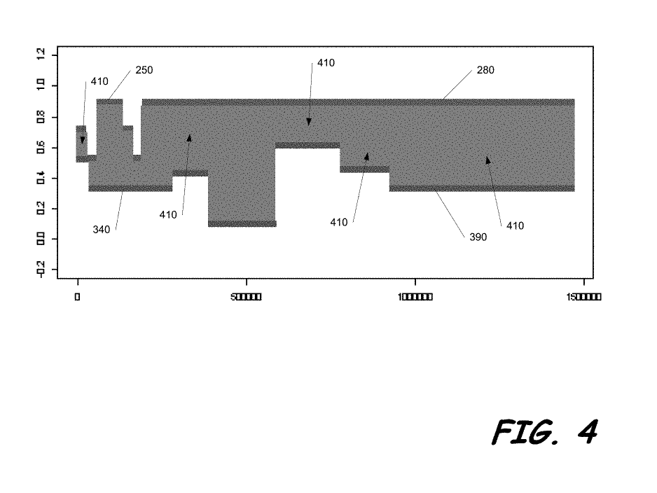

Once the area between the two hashes has been calculated by the distance component 150 the distance component 150 normalizes the area. This is done by dividing the calculated area by the total number of bytes in the file. FIG. 4 illustrates visually the area between the two hashes. In FIG. 4 the graphs of the hashes of FIGS. 2 and 3 have been superimposed on the same graph. The shaded area 410 represents the area between the two hashes.

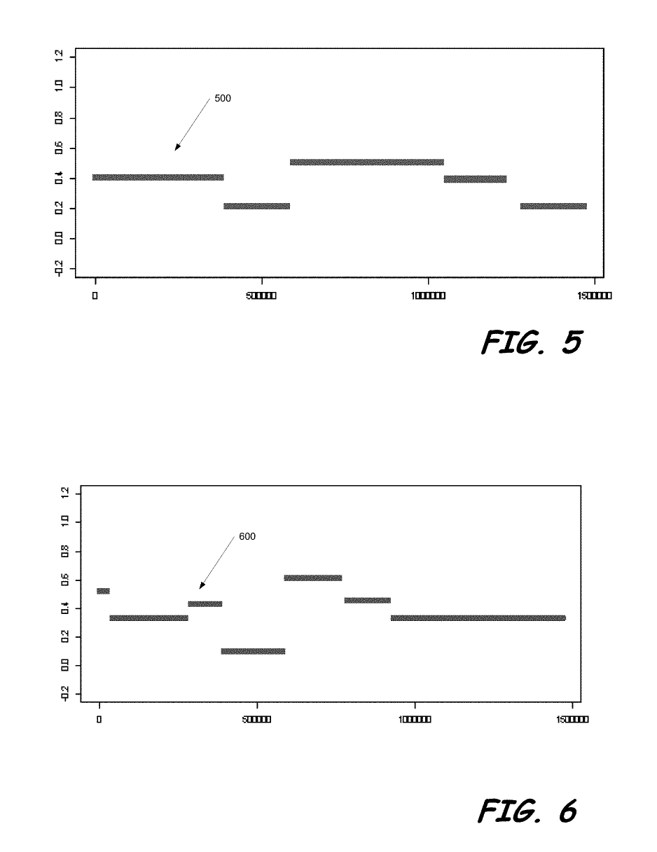

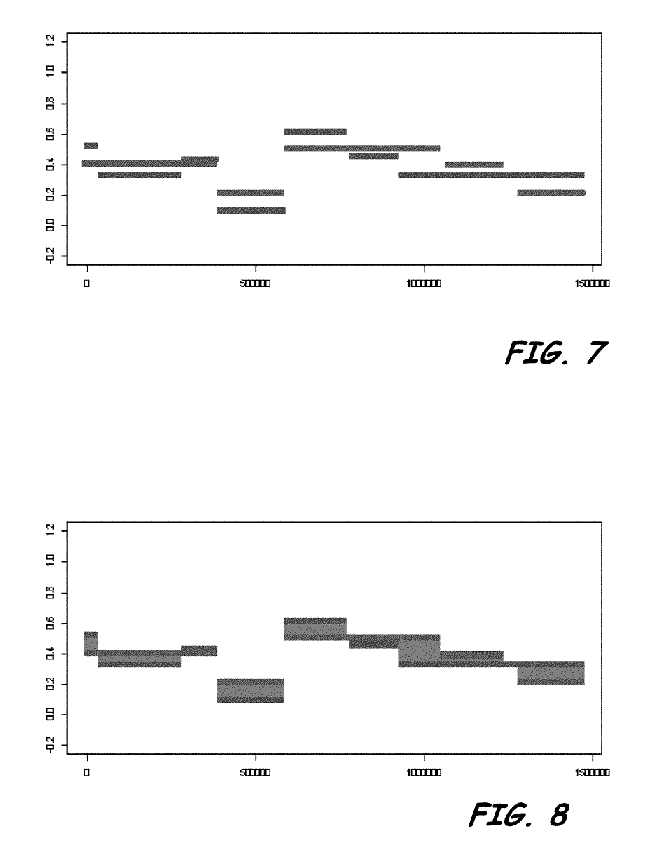

However, one problem with simply considering the area between the two hashes is that two very dissimilar files can have a very low area between them and thus appear to be similar files while exhibiting very different structure. Again to illustrate this FIG. 5 and FIG. 6 illustrate hashes for two different files. FIG. 7 illustrates the two hashes 500 and 600 superimposed on the same graph. It is clear to see in FIG. 7 that the two hashes exhibit very different structure. FIG. 8 illustrates the area between the hashes 500 and 600. If the system simply used the area between the hashes as the single determining factor the result would be that these files would be consider to be more similar to each other.

To address this issue the distance component 150 considers the structure of the hashes as well as the area between the hashes. The distance component 150 can use two different approaches for calculating the difference in structure. The first approach is to calculate the difference between the length of both transition lists. In this approach the number of segments found in the first hash and the number of segments found in the second hash are calculated. The difference between these two numbers is considered the difference of the structure. The second approach is to consider the locations of the transitions themselves in the list. In this approach the distance component 150 simply compares each transition on one hash with the corresponding transition on the other hash. Thus, the location of the first transition of the first hash is compared with the location of the first transition on the second hash. The difference between the byte locations of these transitions is used for the difference value. In some versions of the second approach the distance component 150 can analyze the both hashes to see if there are any transitions that exist in both hashes at the same byte locations. If the distance component 150 locates a location where there is an identical transition point in both hashes, the distance component 150 may consider those locations as equivalent locations and may adjust the transition point calculation accordingly using that point as a base point for the comparison of the hashes. In this way a file that is similar to another, but has a single transition point early in the file that does not align well with the other hash's transition points is not unduly considered different from the other file based on the structure.

The distance component 150 combines these two distance measures and adjusts the impact of these by applying a weighting factor as necessary. The weighting factor allows for the impact of structural difference between hashes to be easily controlled. The result of the combination of these two measures can be expressed according the following:

Given two hashes h₁,h₂ the distance between them is a weighted average:

dist(h₁,h₂)=dₐᵣₑₐ(h₁,h₂)+λd_{structure}(h₁,h₂) EQUATION 2

Where dₐᵣₑₐ(h₁,h₂) measures the area between the two curves defined by h₁,h₂ and d_{structure}(h₁,h₂) measures the distance between the structure of h₁,h₂. λ weights between them.

The result of the comparison can be used by various other components of a computing system. For example, a malware detection component can use these comparisons between the files to identify similarities between the file or portion of the file and known malware files. In another example a spam detection system can compare an incoming email with known malicious emails and block the email if necessary based on the similarity between the incoming email message and known spam or phishing emails. This allows the protection systems to adapt more readily to minor changes to malware made by malware authors. This result is illustrated as output 170. In some approaches the output 170 may be stored on the storage device 160.

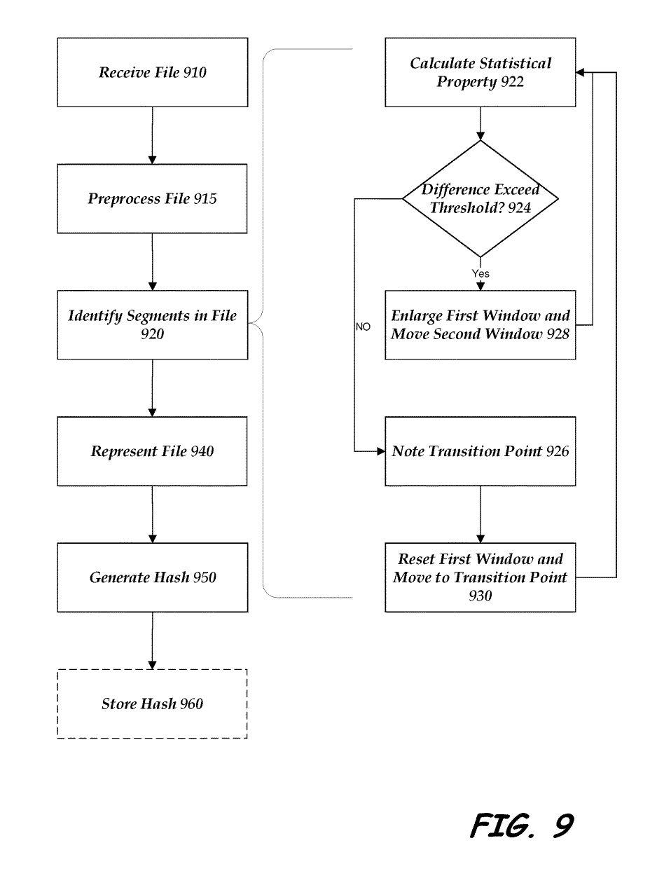

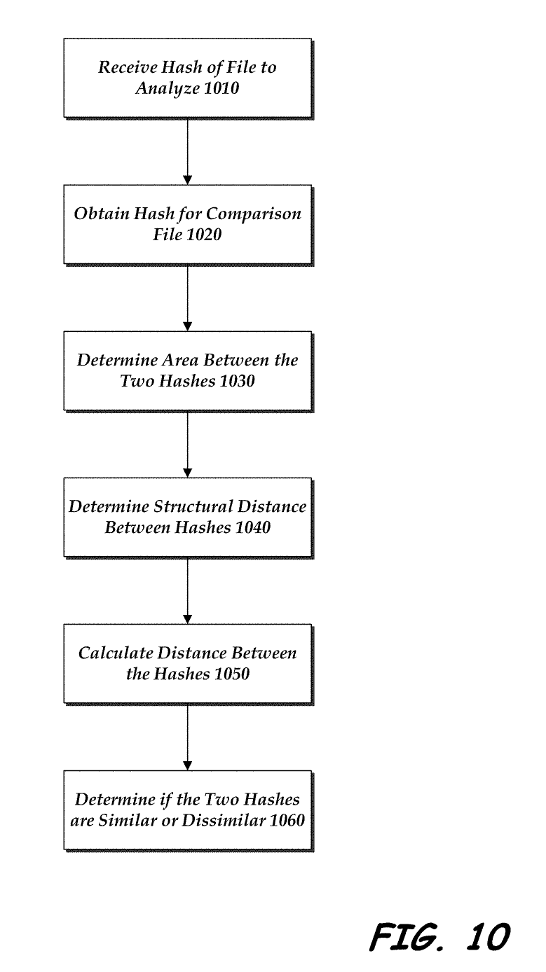

FIG. 9 is a flow diagram illustrating a process that may be implemented by the system to prepare a hash for a file. The process begins when a file is received to be analyzed and have its hash generated. This is illustrated at step 910. As discussed above any type of file can be received at this step. For example, the file can be a file representative of a document, an executable, a photo, a video, music, email, etc.

Once the file has been received the system starts to preprocess the file. This is illustrated at step 915. At this step the system preprocesses the file by taking the file and converting the file into a signal. Each point in the processed signal represents a local entropy for the file at that point. Each point in the processed signal represents a local measure of disorder. In order to generate the processed signal use any method to identify and represent disorder in a signal. In one approach Huffman codes are used to represent the disorder in the file. In this approach the system counts the prevalence of bytes in the file and normalizes them to a probability function (by dividing by the file size). This normalized vector is used as an estimate for the probability density function required to generate the Huffman codes. The output of the preprocessing step is a signal with a size equal to the original file.

Once the file has been converted to the preprocessed signal the file is then segmented. This is illustrated at step 920. At this step the system identifies the transition points in the preprocessed signal. Each of the transition points is representative of the end byte of the particular segment. To find the transition points the system forms two windows of the same size. Each window is representative of a predetermined number of bytes. The two windows are arranged such that the endpoint of the first window is adjacent to the beginning point of the second window. The size of the window can be sized such that the window is capable of capturing or identifying code snipits of a particular interest. For example the window may be sized to identify a known malware signature.

The system takes each of the windows and calculates a statistical property for each of the windows. This statistical property may be, for example, the mean value of the signal or the mean a variance over the size of the window. This is illustrated at step 922 (illustrated within step 920). The difference in the value of the statistical property for the two windows is then compared with a threshold value. This is illustrated at step 924 (illustrated within step 920). If the difference is above the threshold value the system denotes the last byte in the first window as a transition point and holds this point for the later generation of the hash. This is illustrated at step 926 (illustrated within step 920) However, if the comparison falls below the threshold value for the distance the process expands the size of the first window by a predetermined size. As discussed above, the size of the first window can be increased by one byte position. However, other expansion sizes can be considered and used. The second window is then shifted that same number of byte positions, and is not expanded further. This is illustrated at step 928 (illustrated within step 920).

The process continues in after finding the first transition point in the signal moves the first window to begin at the first transition point, reduces the first window back to the original size, and the second window will begin at a point in the signal that is at the end of the size of the first window's original size. This is illustrated at step 930 (illustrated within step 920). Once the first window is moved to the new location the process repeats steps 922-930 and identifies transition points until it reaches the end of the file. The output of step 920 is a segmented version of the signal and a list of transition points.

Following the segmentation of the signal the process continues and creates a representation of the file in a compact manner. This is illustrated at step 940. To represent each segment process may use the same statistical properties that were used in the segmenting process performed by the segmentation component 130. However, different statistical properties can be used to represent the segment. These may be calculated again by the process at this step. The process creates a hash that includes the segments identified at step 920 along with the statistical property chosen at step 940 to generate the hash for the file.

Once the hash has been created the process may store the hash for the file for later retrieval. This is illustrated at step 950. In some approaches only the hash is stored. The hash is stored in a manner that permits the association of the file with the hash. In other approaches the hash is stored along with the file.

FIG. 10 is a flow diagram illustrating a process for determining if two files are similar to each other. The process of FIG. 10 uses a distance measurement applied to two hashes to determine if the two files are similar. The process begins by receiving a hash for a file to be analyzed. This is illustrated at step 1010. In some approaches the process requests the hash for the file from the storage component 160 where the hash had previously been stored. In other approaches the process receives the file and must request a hash to be generated. In this approach the process can implement the process of FIG. 9 and receive the hash for the file following the completion of the process of FIG. 9.

Next the process identifies a file or hash that is to be used to compare the current file with. This is illustrated at step 1020. In some approaches the file or hash that is used is hash that is related to a known piece of malicious code, such as malware or a known phishing email. In other approaches the hash for comparison is a known good file, such as from a whitelist of files and hashes. Again if the file that is chosen for the comparison does not have a readily available hash the process can request that a hash be generated for the file by calling the process of FIG. 9.

Once the two hashes have been identified for the comparison the process begins to determine the distance between the hashes. The process first determines the area between the two hashes. This is illustrated at step 1030. At this step the process considers each of the hashes as a graph of a line and calculates the area between the two lines. Note that each of the hashes contains values associated with the start and end bytes of the segment and a value for that segment. Next the process determines the distance between the two hashes based on the structure between the two hashes. This is illustrated at step 1040. At this step the process can either determine the distance from the endpoints of the corresponding segments in each of the hashes, or the process can simply determine the difference in the number of segments or transitions in the hash. The results of steps 1030 and 1040 are then added together to arrive at a distance for the two hashes. This is illustrated at step 1050. In some approaches a weighting factor can be added to either of the distances measures (area or structure) to allow for balancing or adaption of the impact of either of the distance measures.

Once the distance for the two hashes has been calculated the process can determine if the two hashes are similar on dissimilar. This is illustrated at step 1060. At this step the distance value is compared against a threshold value for similarity. This threshold value can be selected by an administrator or by a program that is using the determined similarity to classify the file. This threshold value can vary between programs that use the output of the process of FIG. 10 based on the desired levels of sensitivity that they achieve. For example a malware detection program may allow a greater difference for the threshold value as indicative of similarity when operating in a high protection mode and a lesser difference for the threshold value as indicative of similarity when operation in a low protection mode.

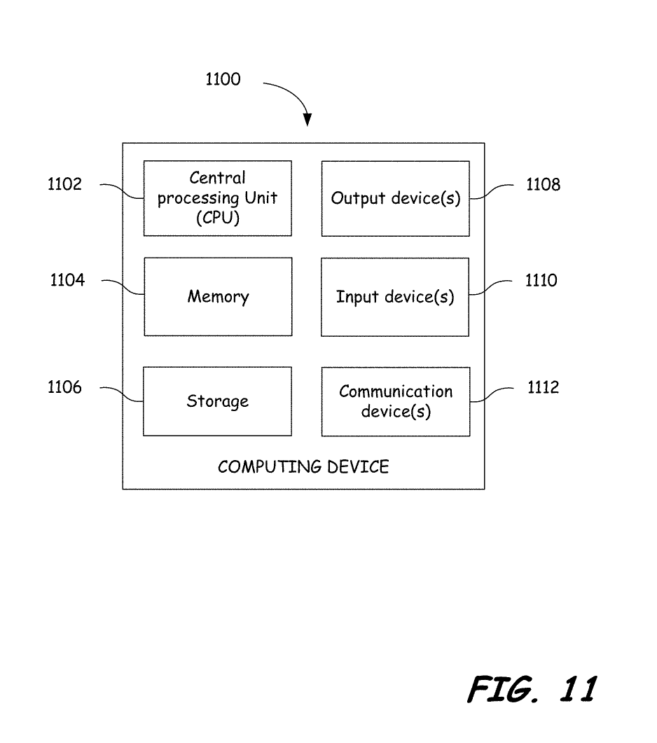

FIG. 11 illustrates a component diagram of a computing device according to one embodiment. The computing device 1100 can be utilized to implement one or more computing devices, computer processes, or software modules described herein. In one example, the computing device 1100 can be utilized to process calculations, execute instructions, receive and transmit digital signals. In another example, the computing device 1100 can be utilized to process calculations, execute instructions, receive and transmit digital signals, receive and transmit search queries, and hypertext, compile computer code, as required by the system of the present embodiments. Further, computing device 1100 can be a distributed computing device where components of computing device 1100 are located on different computing devices that are connected to each other through network or other forms of connections. Additionally, computing device 1100 can be a cloud based computing device.

The computing device 1100 can be any general or special purpose computer now known or to become known capable of performing the steps and/or performing the functions described herein, either in software, hardware, firmware, or a combination thereof.

In its most basic configuration, computing device 1100 typically includes at least one central processing unit (CPU) 1102 and memory 1104. Depending on the exact configuration and type of computing device, memory 1104 may be volatile (such as RAM), non-volatile (such as ROM, flash memory, etc.) or some combination of the two. Additionally, computing device 1100 may also have additional features/functionality. For example, computing device 1100 may include multiple CPU's. The described methods may be executed in any manner by any processing unit in computing device 1100. For example, the described process may be executed by both multiple CPU's in parallel.

Computing device 1100 may also include additional storage (removable and/or non-removable) including, but not limited to, magnetic or optical disks or tape. Such additional storage is illustrated in FIG. 11 by storage 1106. Computer storage media includes volatile and nonvolatile, removable and non-removable media implemented in any method or technology for storage of information such as computer readable instructions, data structures, program modules or other data. Memory 1104 and storage 1106 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 1100. Any such computer storage media may be part of computing device 1100.

Computing device 1100 may also contain communications device(s) 1112 that allow the device to communicate with other devices. Communications device(s) 1112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 1100 may also have input device(s) 1110 such as keyboard, mouse, pen, voice input device, touch input device, etc. Output device(s) 1108 such as a display, speakers, printer, etc. may also be included. All these devices are well known in the art and need not be discussed at length. Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A system for determining similarity between two files comprising:
at least one processor and at least one memory device;
a representation component configured to receive a file and generate a hash of the file, the hash including a list of transitions and a list of levels; and
a distance component configured to determine a distance between the received file and a second file based on a comparison of the hash and a hash for the second file.

2. The system of claim 1 wherein the representation component further comprises:
a preprocessing component, the preprocessing component configured to convert the file to a signal representative of the file.

3. The system of claim 2 wherein the preprocessing component applies a Huffman code to the file to generate the signal.

4. The system of claim 1 wherein the representation component further comprises:
a segmentation component configured to divide a signal associated with the file into at least two segments and provided the segments as the list of transitions.

5. The system of claim 4 wherein the segmentation component is configured to identify a transition point, the transition point representative of a boundary between two segments.

6. The system of claim 4 wherein the segmentation component is further configured to generate a first window having a first size and a second window having a second size, the segmentation component further configured to place the first window at a first byte in the signal and place the second window at a byte following a last byte of the first window.

7. The system of claim 6 wherein the segmentation component is further configured to calculate a first statistical property for the first window and calculate a second statistical property for the second window and compare the first statistical property with the second statistical property and determine if a difference between the first statistical property and the second statistical property exceeds a threshold value.

8. The system of claim 7 wherein the segmentation component is further configured to enlarge the size of the first window when the difference does not exceed the threshold and move the second window to a location following the last byte of the enlarged first window.

9. The system of claim 1 wherein the representation component further comprises:
a represent component configured to identify a statistical property for each transition in the list of transitions.

10. The system of claim 1 wherein the distance component is further configured to calculate the distance based on a calculated area between segments of the hash and segments of the hash of the second file.

11. The system of claim 10 wherein the distance component is further configured to calculate a structural distance between the hash and the hash of the second file.

12. The system of claim 11 wherein the distance component applies a weighting factor to the structural distance.

13. A method of generating a hash for a file comprising:
receiving a file;
preprocessing the file to convert the file to a signal representative of the bytes in the file;
identifying a list of segments in the preprocessed file based on statistical property differences with other portions of the preprocessed file;
representing the preprocessed file by generating a level value for each segment in the list of segments as a list of levels; and
generating a hash of the file, wherein the hash comprises the list of segments and the list of levels.

14. The method of claim 13 wherein identifying the list of segments further comprises:
determining a size of a first window;
placing the first window on a first byte of the preprocessed file;
placing a second window at a first byte position after an end byte of the first window;
calculating a first statistical property for the first window and a second statistical property for the second window; and
determining if a difference between the first statistical property and the second statistical property exceeds a threshold value; and
noting as a transition point the end byte when the difference exceeds the threshold value.

15. The method of claim 14, when the difference does not exceed the threshold value, further comprising:
increasing the size of the first window;
moving the second window to the first byte position after a new end byte of the first window; and
repeating the steps of calculating, determining and noting.

16. The method of claim 14 when the difference exceeds the threshold value, further comprising:
moving the first window to the first byte position of the second window;
resetting the size of the first window to an original size; and
repeating the steps of placing, calculating, determining and noting for the first window and the second window for the new location.

17. The method of claim 13 wherein the level value is generated by calculating a statistical property for each segment in the list of segments.

18. A computer readable storage device having computer executable instructions that when executed by at least one computer cause the at least one computer to:
receive a hash of a file to analyze;
obtain a second hash, the second hash representative of a second file to compare with the file;
determine an area between the hash and the second hash;
determine a structural distance between the hash and the second hash;
calculate a distance between the hash and the second hash based on the area and the structural distance;
determine if the two hashes are similar or dissimilar based on a comparison of the calculated distance to a threshold value.

19. The computer readable storage device of claim 18 wherein calculate the distance between the hash and the second hash further comprises instructions to applying a weighting factor to the structural distance.

20. The computer readable storage device of claim 18 wherein receive a hash of a file further comprises instructions to:
receive the file;
provide the file to a representation component; and
receive from the representation component a hash of the file.
